(19) United States
(12) Patent Application Publication
(10) Pub. No.: US 2017/0191699 A1
(43) Pub. Date: Jul. 6, 2017

(54) FASTENING DEVICE FOR FASTENING AT LEAST ONE SOLAR COLLECTOR, METHOD FOR FASTENING A SOLAR COLLECTOR, AND METHOD FOR DISMOUNTING A SOLAR COLLECTOR

(71) Applicant: DOMETIC S.A.R.L., Hosingen (LU)

(72) Inventors: Josef MÜLLER, Bollendorf (DE); Andreas HOFFMANN, Ammeldingen (DE)

(21) Appl. No.: 15/326,125

(22) PCT Filed: Jul. 15, 2014
(86) PCT No.: PCT/EP2014/065168

§ 371 Date: Jan. 13, 2017

(51) Int. Cl. F24J 2/52; E04H 12/00; H02S 20/10

(52) U.S. Cl. CPC F24J 2/5245; F24J 2/525; F24J 2/5252; H02S 20/10; E04H 12/00; F24J 2002/4658

(57) ABSTRACT

The present invention relates to a fixing device 1 for fixing at least one solar collector 2 to a site of installation 3, preferably to a pylon 4, wherein the fixing device 1 comprises a collector pedestal 5 for the at least one solar collector 2 that can be fixed to the pylon 4, a reversing device 6 that can detachably be fixed to the pylon 4, a winch device 7, a lift body 8 that is moveable along the pylon 4, and a hauling element 9, wherein the hauling element 9 with a first end 10 is fixed to the winch device 7 and with a second end 11 is fixed to the lift body 8, wherein the hauling element 9 between the first end 10 and the second end 11 is at least partially guided at the reversing device 6, wherein the hauling element 9 is fixed to the winch device 7 such that the length of the hauling element 9 between the winch device 7 and the lift body 8 can be reduced by the hauling element 9 and that the reversing device 6 reverses the hauling element 9 above the site of installation 3 of the at least one solar collector 2 at the pylon 4. Further, the invention relates to a method for fixing a fixing device and a method for demounting a fixing device.

The present invention relates to a fixing device for fixing at least one solar collector to a site of installation, preferably to a pylon or the like. Further, the present invention relates to a method for fixing a solar collector as well as a method for demounting a solar collector.

Solar collectors are often employed in remote areas, especially in developing countries and disaster areas, respectively, in which a stable, safe, and continuous energy supply, for example via electricity supply or other decentralized power generating devices, cannot be ensured. For example, in case of diesel generators continuous supply with diesel fuel sometimes is a problem. In such areas solar collectors often represent the only possibility to supply power-consuming apparatuses such as for example cellular phones, cooling devices, or notebooks with power.

In order to optimally employ solar collectors, especially for maximizing the energy production by means of the solar collectors, it is necessary to place the solar collectors at a site at which they receive a highest possible incidence of sunlight throughout the day. In order to avoid shading, for example by vegetation or surrounding buildings, solar collectors thus usually are placed at an elevated—i.e. exposed—place.

While in inhabited areas basically locations on high roofs of sufficiently stable buildings are used, in areas that are only sparely built up and with an inadequate construction quality or that are even completely uninhabited, but very suitable for the energy production my means of solar collectors, ground-level set-ups or also pylons are used on or to which the solar collectors can be fixed. Especially, attachment of the solar collectors to pylons appears to be advantageous here, since such pylons can easily be fabricated and placed in almost any environment.

Also, with such pylons the arrangement of the solar collectors becomes completely independent of the density and quality of the prevailing buildings. Here, the term pylon in the meaning of the application means any preferably tubular formed set-up that in its axial extension extends substantially perpendicularly upwards from the ground. Pylons can be easily prepared from natural materials, for example wood, but also from metallic or other suitable materials and, for fixation, can be brought into the ground by or, if necessary, without using a foundation. Of course, such pylons can also be protected from tilting or falling over by further suitable and well-known safety measures.

A further advantage of employing pylons is that the solar collectors are well inhibited from theft and separated from an unwanted access of third parties. While solar collectors mounted on roofs or ground-level set-ups are generally accessible without any restriction and thus, can easily be damaged or stolen, a solar collector attached to a sufficiently high pylon is out of reach of the unwanted access by third parties. So, also any kind of manipulation on the solar collector is prevented.

Due to the high weight of solar collectors they are usually fixed to the desired elevated site of installation with the aid of a crane that lifts the solar collectors to the elevated site of installation. There, they are then fixed to the respective building or pylon. It is a disadvantage of the need of a crane that in many areas in which solar collectors are employed, especially in developing countries or disaster areas, a crane is available only in special circumstances. Often, on the spot only here and there primitive means such as for example climbing aids are available with which the installation of solar collectors is only done under a considerable effort in single parts and under the partially increased risk of injuries for the mounting staff and especially also the risk of damages of the solar collectors.

Thus, it is the object of the present invention to provide a fixing device as well as a method for fixing and demounting at least one solar collector to a site of installation, such as for example to a pylon or the like so that a safe mounting by using the simplest means is possible.

The solution of the problem is obtained with a fixing device according to claim 1, a method for fixing according to claim 12, and a method for demounting according to claim 14. Advantageous developments are described in the sub-claims.

The fixing device according to the invention over the above-described fixing devices known from the prior art is characterized in that the fixing device comprises a collector pedestal for at least one solar collector that can be fixed to the pylon, a reversing device that can detachably be fixed to the pylon, a winch device, a lift body that is movable along the pylon and a hauling element. Here, the hauling element with a first end is fixed to the winch device and with a second end is fixed to the lift body, wherein the hauling element is at least partially guided at the reversing device between the first and the second ends. According to the invention the hauling element is fixed to the winch device such that the length of the hauling element between winch device and the lift body can be reduced by the hauling element and that the reversing device reverses the hauling element above the site of installation of the at least one solar collector at the pylon. With the fixing device at least one solar collector can be securely fixed to a pylon that is already available on the spot or to be placed. Suitable pylons especially are pylons of telegraph or power supply lines, but also high posts, columns of buildings or straight grown stems of trees to which the collector pedestal for the at least one solar collector can be fixed. The construction of the fixing element provides that the winch device also is detachably fixed either to the base of the pylon itself near the ground or to a fixed point close to the base of the pylon, respectively, for example also by ground nails or the like directly on the ground at the pylon. The hauling element is guided at the reversing device above the site of installation of the at least one solar collector. The result is that upon reducing the length of the hauling element between the winch device and the lift body, the lift body is pulled towards the reversing device. Thereby, the collector pedestal can be lifted by the lift body.

For fixing the reversing device various possibilities may be considered. So, for example the reversing device can be fixed to the pylon by means of a tube length that is closed at one end. For fixing the reversing device to the pylon the open end of the tube length is put over the end of the pylon opposite to the base. Here, the length of the tube length prevents the reversing device from laterally falling off the pylon. Alternatively, the reversing device can also be fixed to the pylon by means of pylon clamps or the like.

In a preferred embodiment of the fixing device the reversing device has at least one reverse body, wherein the at least one reverse body guides the hauling element. The guidance of the hauling element prevents the hauling element from slipping on the reversing device or tilting. This ensures that the hauling element does not come off the reversing device, while the hauling element as a result of the reduced length of the hauling element between the winch device and the lift body moves over the reversing device.

In a further development the at least one reverse body is a pulley. The pulley is preferably supported, e.g. by ball bearings, such that it can freely rotate on the reversing device. In this way, the hauling element is guided over the at least one reverse body with particularly low friction and safe, thereby avoiding damages to the hauling element as a result of an otherwise occurring friction load.

It is of advantage if the hauling element is a cable and the winch device is a cable winch. The use of a cable winch as the winch device considerably simplifies reducing the length of the hauling element by winding a cable and thereby pulling the lift body that is movable along the pylon towards the reversing device. The winch can be driven with a crank handle. As suitable cables wire or plastic cables are possible, among others. This also makes it possible to maintain the overall simple structure of the fixing device.

It is of advantage for the design of the fixing device if the cable winch has a motor, especially an electric motor, for driving. In this way, the cable can very easily be wound up to the cable winch. At the same time the collector pedestal with one or more heavyweight solar collectors is moved to its site of installation against the force of gravity by the lift body along the pylon without any physical exertion.

Suitably, the lift body can have a guiding means, wherein the guiding means abuts on the pylon. Preferably, the guiding means is configured such that it at least partially surrounds the pylon, wherein between the pylon and the guiding means there is present a distance, so that the guiding means can move along the pylon. This prevents the lift body that is movable along the pylon from swinging around the pylon due to a force that is horizontally applied, for example by wind, while it hangs on the hauling element. Such a swinging is not desired, since in this way lifting the lift body with the collector pedestal as well as the solar collector fixed thereto can result in a damage of the same.

Preferably, the guiding means has at least one pulley that abuts on the pylon. The abutting pulley is preferably supported, e.g. by ball bearings, such that it can freely rotate around the guiding means. Moving the lift body with the guiding means along the pylon can result in friction and tilting of the guiding means on the pylon. This is prevented by the use of at least one pulley that abuts on the pylon. At the same time, the clearance present due to the distance between pylon and guiding means is minimized so that undesired pendulum motions are effectively minimized, too.

It is of advantage if the guiding means has at least one first guiding means part and one second guiding means part, wherein the distance between the first guiding means part and the second guiding means part can be adjusted. By adjusting the distance between the guiding means parts it is possible that the guiding means can be adapted to pylons of different thicknesses and thereby, the fixing device universally can be employed with a number of pylons of different diameters. Moreover, also the distance between the pylon and the guiding means can be adjusted such that no clearance between the pylon and the abutting pulleys of the guiding means occurs which particularly effectively avoids undesired pendulum motions.

In order to alternatively adapt the guiding means to pylons of different thicknesses the guiding means can have at least two pulleys abutting on the pylon the distance of which to each other perpendicular to the pylon can be adjusted. Here it is preferred that the at least two pulleys abutting on the pylon are arranged around the pylon on opposite sides of the pylon. The distance of the at least two pulleys, which abut on the pylon, to each other and towards the pylon can be adjusted by elongated holes, for example. By loosening a threaded joint connecting the rotational axis of the pulley abutting on the pylon to the guiding means, the rotational axis becomes displaceable in the elongated hole and can be displaced perpendicular to the pylon so that a clearance between the at least two pulleys abutting on the pylon and the pylon no longer occurs. By subsequently tightening the threaded joint the rotational axis again is fixed to the guiding means. In this way, undesired pendulum motions are particularly effectively avoided. Moreover, the distance between the first guiding means part and the second guiding means part needs not to be adjusted what makes the construction of the guiding means easier.

Suitably, the collector pedestal can be moved by means of the lift body along the pylon. By reducing the length of the hauling element between the winch device and the lift body the collector pedestal is moved along the pylon towards the reversing device above the site of installation of the at least one solar collector on the pylon. For that, the lift body is arranged at the pylon below the collector pedestal so that the collector pedestal rests on the lift body due to the gravity. Alternatively, the lift body can be arranged at the pylon also above or laterally of the collector pedestal. In this case, there is present a connection between the lift body and the collector pedestal such that the collector pedestal can be moved by the lift body on the pylon towards the site of installation.

In a further development the collector pedestal has at least two pylon clamps that can be moved substantially perpendicular to the pylon so that the collector pedestal can be clamped to the pylon. For that, the pylon clamps are preferably connected to each other via at least one threaded joint or the like. By actuating the at least one threaded joint the pylon clamps are moved toward each other substantially perpendicular to the pylon so that the distance between the pylon clamps is reduced and the pylon is clamped. Since the distance between the pylon clamps can be adjusted by the at least one threaded joint the collector pedestal can be fixed to pylons of different diameters. Accordingly, the fixing device can be fixed to a number of pylons by simply actuating the at least one threaded joint without having to make major structural changes to the fixing device.

It is of advantage if the at least one solar collector can be fixed to the collector pedestal via at least one clamp connection. Here, the at least one clamp connection is configured such that the at least one solar collector in the non-clamped state of the at least one clamp connection can be changed in its inclination. In this way, the surface of the solar collector can be oriented substantially orthogonal to the sun to increase energy production. By closing the at least one clamp connection the solar collector is clamped in the desired position and thus, fixed to the collector pedestal.

The method according to the invention for fixing a solar collector to a pylon or the like with a fixing device according to the invention is characterized in that the method comprises the following steps:
fixing the reversing device to the pylon above the site of installation of the at least one solar collector; and
fixing the winch device to the pylon; and
fixing the lift body to the pylon so that the lift body can be moved along the pylon; and
fixing the first end of the hauling element to the winch device; and
fixing the second end of the hauling element to the lift body, wherein the hauling element is guided over the reversing device; and
mounting the at least one solar collector to the collector pedestal; and
connecting the collector pedestal to the lift body;
actuating the winch device so that the length of the hauling element between the winch device and the lift body is reduced so that the lift body and the collector pedestal connected to the lift body are moved along the pylon; and
fixing the collector pedestal to the pylon as soon as the at least one solar collector has reached the desired site of installation at the pylon.

That is, first the reversing device is fixed above the site of installation of the at least one solar collector on the pylon. Generally, for that only a ladder is required as an aid with which the mechanic climbs up to above the desired site of installation of the at least one solar collector on the pylon. Then, according to the design of the pylon the reversing device can be put onto the pylon for example from above by inserting the pylon into the tube element closed on one side. Alternatively, when the pylon has a larger diameter than the inner diameter of the tube element closed on one side or the end of the pylon is out of reach of the ladder, the reversing device can laterally be fixed to the pylon for example by means of pylon clamps that are laterally present on the reversing device. Of course, other fixing options are also conceivable.

Then, as the second step the winch device is fixed to the pylon. Here, the winch device is fixed to the base of the pylon at ground level or close to the base of the pylon below the site of installation of the at least one solar collector on the pylon. The winch device can be fixed with pylon clamps, alternatively, the winch device can also be fixed to a fixed point on the base of the pylon, for example on the bumper of a vehicle standing at the base of the pylon or the like.

In a third step the lift body is fixed to the pylon such that it can be moved along the pylon. Preferably, for that the guiding means is put around the pylon and the at least first guiding means part and the at least second guiding means part are adjusted in the distance to each other such that the at least one pulley of the guiding means abuts on the pylon so that the guiding means can be moved on the pylon without catching or rubbing on the pylon.

In a fourth step the first end of the hauling element is fixed to the winch device and in a fifth step the second end of the hauling element is fixed to the lift body, wherein the hauling element is guided over the reversing device. For that, the mechanic of the fixing device climbs up the pylon, for example with the aid of a ladder, and guides the hauling element over the reversing device such that the hauling element is guided by the at least one reverse body and the hauling element is prevented from slipping off the reversing device sideways. The second end of the hauling element can be fixed to the lift body for example by hooking a spring hook present on the hauling element into the lift body.

In a sixth step, the at least one solar collector is mounted to the collector pedestal. Preferably, in preparation the surfaces of the at least one solar collector at first are oriented as is ideal for the later mounting to the site of installation, namely such that the insolation hits the surface of the at least one solar collector as perpendicularly as possible. As soon as the at least one solar collector is oriented, the at least one clamp connection is tightened so that the at least one solar collector is clamped to the collector pedestal.

In the seventh step, the collector pedestal is connected to the lift body. This is preferably achieved such that the collector pedestal is put on the lift body above the lift body so that it rests on the lift body due to gravity. Alternatively, the collector pedestal can also be connected to the lift body below or to the side of the lift body, for example by hooking in a spring hook or the like.

The eighth step includes actuating the winch device such that the length of the hauling element between the winch device and the lift body is reduced. Since the winch device is stationary fixed to the pylon or to a fixed point at the base of the pylon, respectively, and the reversing device is fixed to the pylon above the site of installation of the at least one solar collector, reducing the hauling element guided over the reversing device causes that the lift body is moved by the hauling element towards the reversing device. Thereby, the lift body also lifts the collector pedestal connected to the lift body. Since the reversing device is fixed to the pylon above the site of installation of the at least one solar collector, the lift body can lift the collector pedestal up to the site of installation of the at least one solar collector.

In a ninth step, the collector pedestal is fixed to the pylon as soon as the at least one solar collector has reached the desired site of installation on the pylon. Preferably, for that the at least one threaded joint of the pylon clamps on the collector pedestal is actuated such that the distance between the pylon clamps is reduced and in this way, the pylon is clamped between the pylon clamps. Of course, alternative fixing options of the collector pedestal are also conceivable.

It is an advantage of the inventive method for fixing at least one solar collector to a pylon that except of a ladder and optionally standard tools for actuating threaded joints generally no further means are required to fix the at least one solar collector to the pylon or the like. In general, the above-mentioned means are worldwide and universally available, so for example also in remote areas such as developing countries or disaster areas, so that the fixing device can be employed without any further aids.

It is suitable that after fixing the solar collector to the pylon the connection between the lift body and the collector pedestal is loosened and the reversing device that can be fixed to the pylon, the winch device, the lift body that is movable along the pylon and the hauling element are demounted from the pylon. Accordingly, on the pylon there only remain the collector pedestal as well as the at least one solar collector that is fixed and especially clamped to the collector pedestal. Such a procedure is of advantage, since in this way an unauthorized demounting of the solar collector from the pylon is effectively complicated if not even prevented.

Further, the invention comprises a method for demounting the at least one solar collector from a pylon or the like, wherein the demounting comprises the following processing steps:
fixing the reversing device to the pylon above the site of installation of the at least one solar collector, and
fixing the winch device to the pylon, and
fixing the lift body to the pylon such that it can be moved along the pylon, and
fixing the first end of the hauling element to the winch device, and
fixing the second end of the hauling element to the lift body, wherein the hauling element is guided over the reversing device, and
connecting the collector pedestal to the lift body,
loosening the fixation of the collector pedestal on the pylon, and
actuating the winch device such that the length of the hauling element between the winch device and the lift body is increased, so that the lift body and the collector pedestal connected to the lift body are moved along the pylon, and
loosening the at least one clamp connection between the collector pedestal and the at least one solar collector, so that the at least one solar collector can be taken off the collector pedestal, and
demounting the reversing device on the pylon, the winch device of the lift body that is moveable along the pylon, the hauling element, and the collector pedestal from the pylon.

Thus, with the method for demounting the fixing device according to the invention there result substantially the identical advantages as with the method for fixing the fixing device according to the invention. Thus, except of a ladder and optionally standard tools for actuating threaded joints generally no further means are required to fix the at least one solar collector to the pylon or the like. Therefore, a particularly simple and uncomplicated demounting is possible.

In the following, the invention is explained in detail with respect to examples described in the drawings. Here:

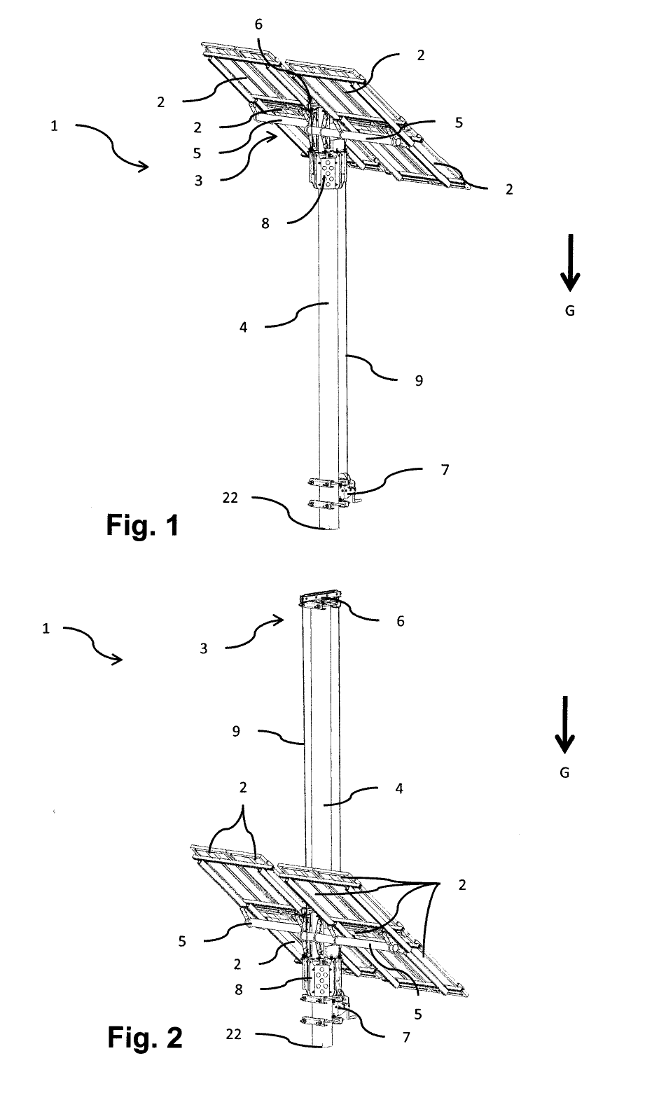

FIG. 1 schematically shows an example of the fixing device for fixing eight solar collectors to a pylon;

FIG. 2 schematically shows a fixing device according to the example shown in FIG. 1, wherein the solar collectors are below the site of installation on the pylon;

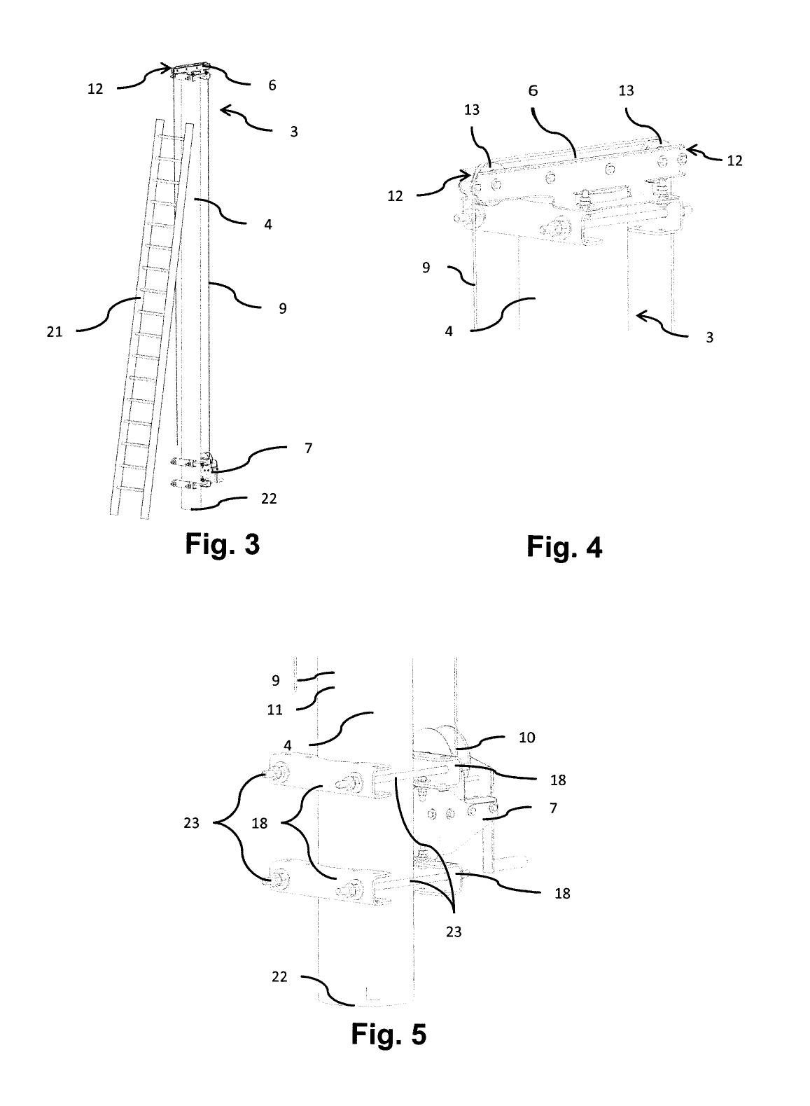

FIG. 3 schematically shows a view of a fixing device according to FIG. 1 that is partially mounted to the pylon;

FIG. 4 schematically shows a detail view of the reversing device of the fixing device shown in FIG. 1;

FIG. 5 schematically shows a detail view of the winch device on the base of the pylon according to the fixing device shown in FIG. 1;

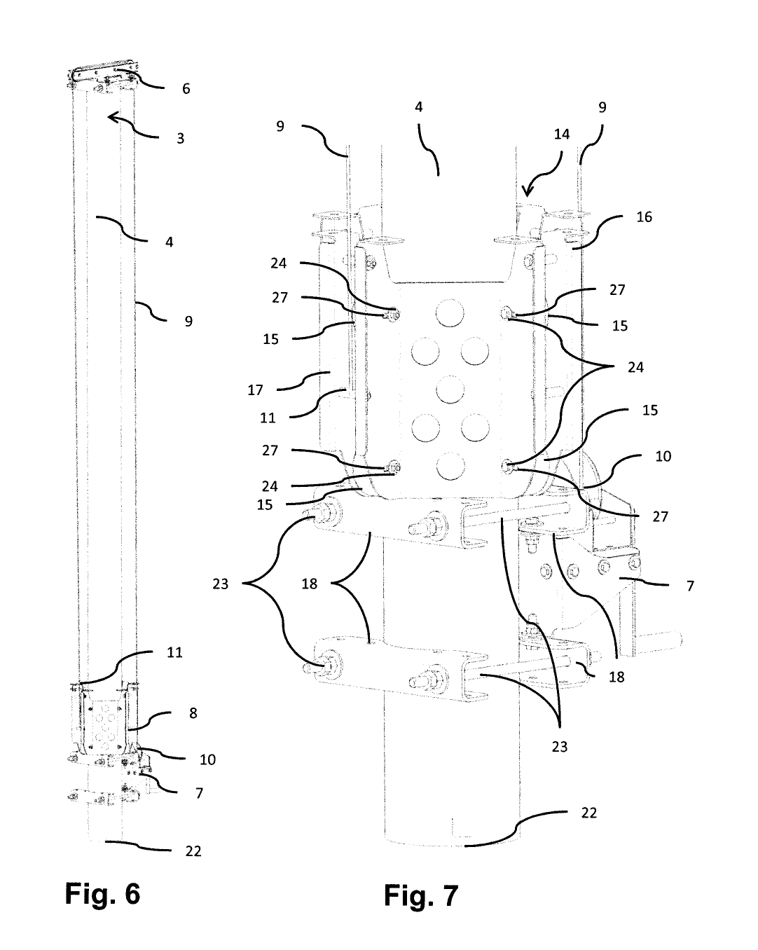

FIG. 6 schematically shows a view of the fixing device according to FIG. 1 without a collector pedestal and solar collectors;

FIG. 7 schematically shows a detail view of the winch device, the hauling element as well as the lift body of the fixing device shown in FIG. 1;

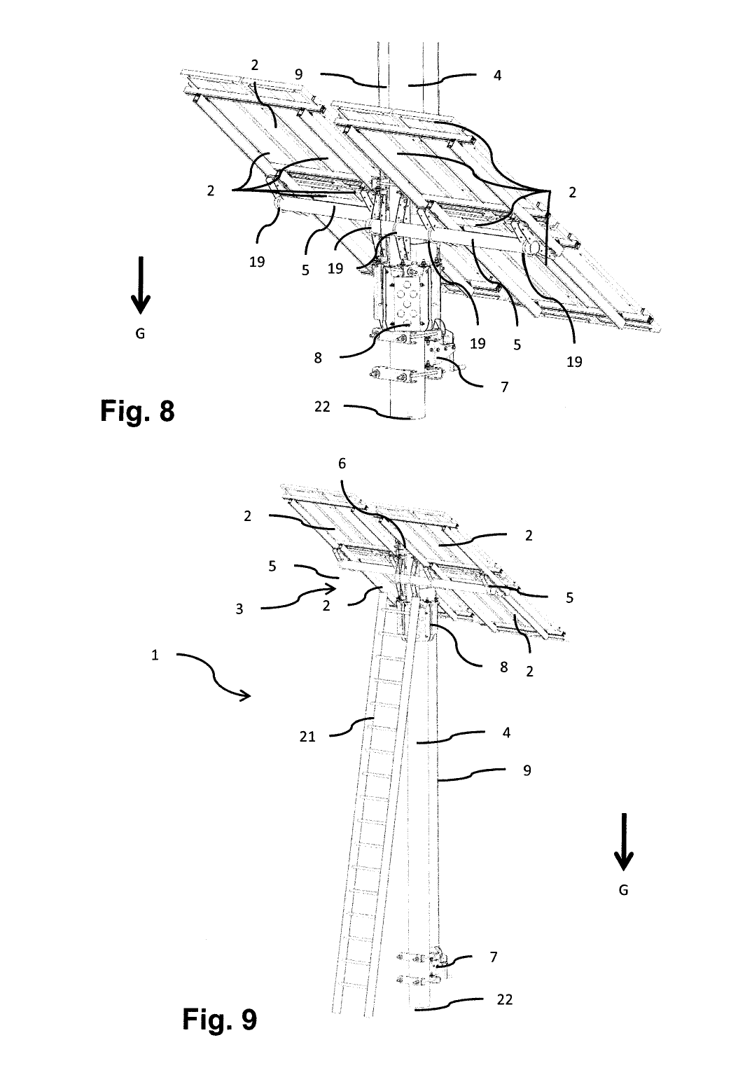

FIG. 8 schematically shows a detail view of the fixing device according to FIG. 1, wherein the winch device of the lift bodies as well as the collector pedestal with solar collectors are shown on the pylon below the site of installation of the solar collectors;

FIG. 9 schematically shows a detail view of the fixing device according to FIG. 1 with the solar collectors at their site of installation; and

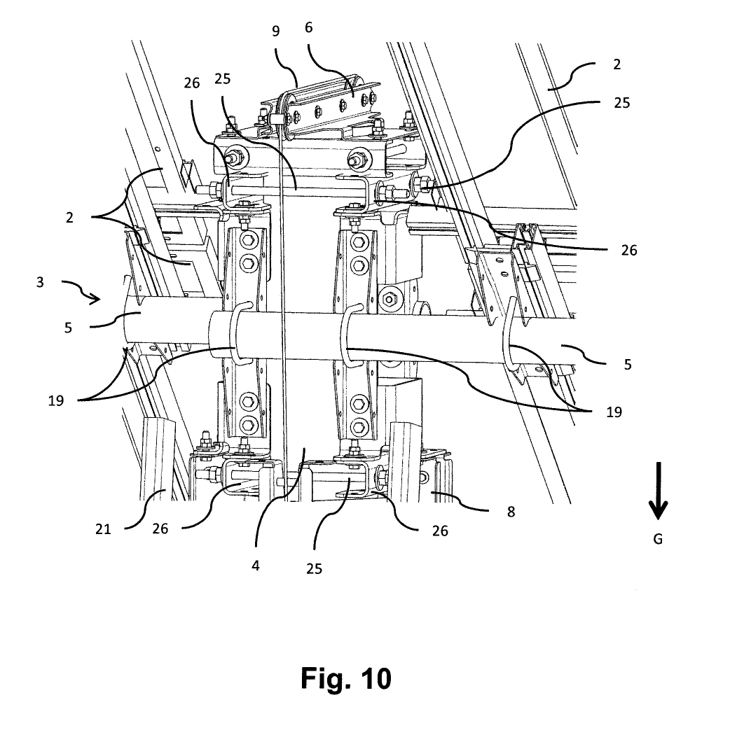

FIG. 10 schematically shows a detail view of the fixing device according to FIG. 1 with the solar collectors at the site of installation and a means for mounting; and

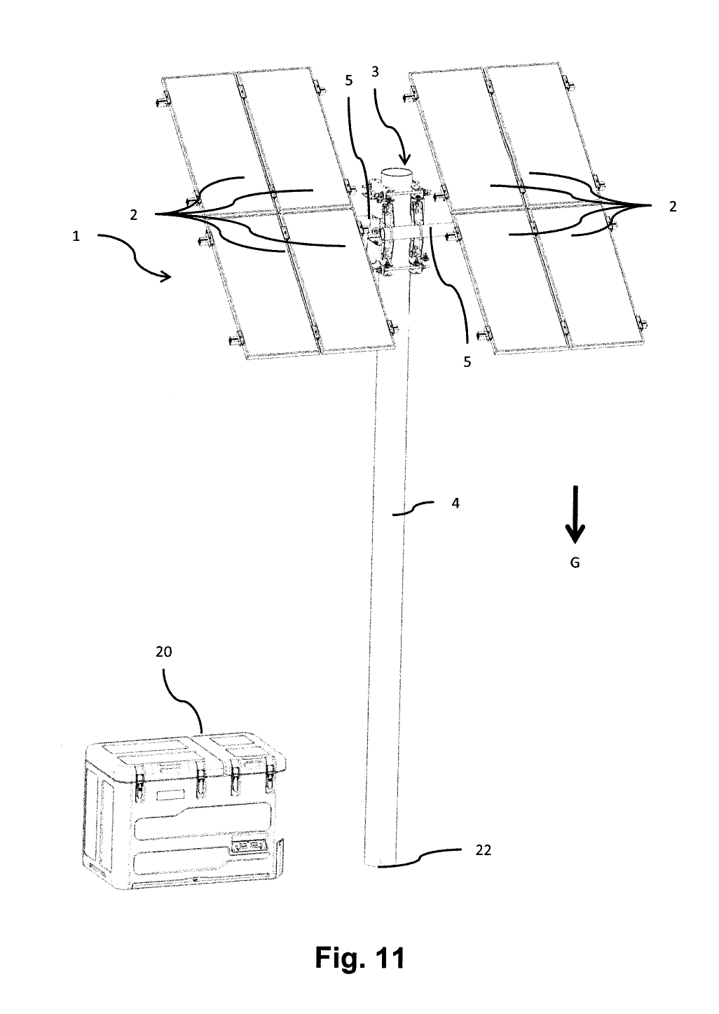

FIG. 11 schematically shows a view of the fixing device according to FIG. 1, wherein the fixing device is secured against unauthorized removal.

FIG. 1 shows a fixing device 1 according to the invention for fixing eight solar collectors 2 to a pylon 4. The illustrated embodiment has two collector pedestals 5 to each of which four solar collectors are fixed at the site of installation 3 at the pylon 4. Further, there is shown the reversing device 6 that is fixed to the pylon 4 above the site of installation 3. Below the site of installation 3 there is arranged the lift body 8 that is connected to the winch device 7 at the base of the pylon 22 via the hauling element 9. In this example, the hauling element 9 is a cable. Here, the hauling element 9 or cable, respectively, is guided over the reversing device 6. Further, the length of the hauling element 9 is reduced.

The fixing device 1 shown in FIG. 2 corresponds to fixing device 1 illustrated in FIG. 1, wherein the hauling element 9 or cable, respectively, guided over the reversing device 6 is not yet shortened. This means that the lift body 8 that is connected to the winch device 7 via the hauling element guided over the reversing device 6 is in a position below the site of installation 3. The two collector pedestals 5 are arranged above the lift body so that they rest on the lift body 8 due to gravity G.

FIG. 3 is a view of the fixing device 1 that is partially mounted to the pylon. The reversing device 6 is fixed to the pylon 4 with the reverse body 12 above the site of installation 3. As the means for fixing the reversing device 6 to the pylon 4 there is shown a ladder 21 that is leaned against the pylon 4 so that a mechanic (not shown) can climb the pylon 4 to fix the reversing device 6 to the pylon 4. FIG. 3 further shows how the hauling element 9 or cable, respectively, is guided over the reversing device 6 by the winch device 7.

A detailed illustration of the reversing device 6 is shown in FIG. 4. The reversing device 6 fixed to the pylon 4 has two reverse bodies 12 that are realized as pulley 13. With the help of the two pulleys 13 the hauling element 9 is guided over the reversing device 6, wherein the pulleys minimize the friction between the reversing device 6 and the hauling element 9 or the cable, respectively, and effectively prevent the hauling element 9 or cable, respectively, from coming off or catching.

FIG. 5 is a detail view of the fixing device 1 in which there is illustrated the winch device 7 and its fixation to the pylon in the form of pylon clamps 18. In the embodiment shown, the winch device 7 with a total of four first pylon clamps 18 is fixed to the pylon 4 above the base of the pylon 22 such that two first pylon clamps each are opposite. The opposite first pylon clamps 18 are connected to two first threaded joints 23 such that the distance between the opposite first pylon clamps 18 substantially orthogonal to the pylon 4 can be reduced and thus, the winch device 7 can be clamped to the pylon 4 by actuating the first threaded joint 23. It is further shown, that the first end 10 of the hauling element 9 or cable, respectively, is fixed to the winch device, whereas the second end 11 of the hauling element 9 or cable, respectively, is still free.

FIG. 6 shows the fixing device 1 that is partially mounted to the pylon 4, wherein in contrast to FIG. 3 already the lift body 8 is displaceably fixed to the pylon. The second end 11 of the hauling element 9 or cable, respectively, is fixed to the lift body 8. The first end 10 of the hauling element 9 or cable, respectively, guided over the reversing device 6 is fixed to the winch device 7. The winch device 7 is fixed to the pylon 4 in the vicinity of the base of the pylon 22. Since the hauling element 9 or cable, respectively, is not yet shortened, the lift body 8 is in a position below the site of installation 3 of the at least one solar collector 2.

FIG. 7 is a detail view of the winch device 7 illustrated in FIG. 6 as well as the lift body 8. As already illustrated in FIG. 5 it can be seen that the winch device 7 is fixed to the pylon 4 by means of four first pylon clamps 18. Here, two first pylon clamps 18 each are connected to a threaded joint 23 such that the distance of the pylon clamps upon actuating the threaded joint orthogonal to the pylon 4 is reduced and thus, the pylon 4 is clamped between the first pylon clamps 18.

Further, it can be seen that the lift body 8 has a guiding means 14 that is built up of four guiding means parts of which in FIG. 7 there can be seen a first guiding means part 16 as well as a second guiding means part 17. Of the total of eight pulleys 15 of the guiding means 14 that abut on the pylon, four can be seen in FIG. 7. The eight pulleys 15 abutting on the pylon are arranged at the guiding means 14 around the pylon in two planes lying above each other with four pulleys 15 each that abut on the pylon. Here, the four pulleys 15 in one plane that abut on the pylon are offset to each other by an angle of 90°. The rotational axis of each of the pulleys 15 abutting on the pylon is connected to the guiding means 14 by a second threaded joint 24 each. Here, the second threaded joint 24 is passed through an elongated hole 27 such that the second threaded joint 24 together with the respective rotational axis can be displaced perpendicularly toward the pylon 4. As a result, thus each of the pulleys 15 abutting on the pylon can be displaced perpendicularly to the pylon 4. Further, it can be seen in FIG. 7 that the hauling element 9 with a first end 10 is fixed to the winch 7 and with the second end to the lift body 8.

In a not-shown example the lift body also has a guiding means that is built up of a first guiding means part and a second guiding means part. However, in contrast to the embodiment shown in FIG. 7 the first guiding means part and the second guiding means part can be adjusted in their distance to each other by two fourth threaded joints so that the abutting pulleys of the guiding means abut on the pylon. In analogy to the embodiment illustrated in FIG. 7 the guiding means of the not-shown example preferably has eight pulleys abutting on the pylon. As also shown in FIG. 7, in the not-shown example the hauling element with a first end is fixed to the winch and with the second end to the lift body.

FIG. 8 shows a detail view of the fixing device 1. Here, the winch device 7 is connected to the lift body 8 via the hauling element 9 or cable, respectively. The winch device 7 is fixed to the pylon 4 in the vicinity of the base of the pylon 22, whereas the lift body 8 is moveably arranged at the pylon 4. The two collector pedestals 5 with the four solar collectors 2 each are arranged above the lift body 8 such that the collector pedestals 5 rest on the lift body 8 due to gravity G. Four solar collectors 2 each are connected to one collector pedestal 5 by two clamp connections 19. It can be seen that the solar collectors 2 are inclined over the vertical so that the solar collectors are oriented toward the sun. It is further seen in FIG. 8 that the hauling element 9 or cable, respectively, still is not shortened.

In FIG. 9 there is shown a fixing device in which the hauling element 9 or cable passed by the winch device 7 over the reversing device 6 to the lift body 8 has been shortened such that the lift body 8 has moved along the pylon 4 toward the reversing element 6. Thereby, the two collector pedestals 5 having the eight solar collectors 2 present thereon and being arranged above the lift body 8 were lifted toward the site of installation 3 of the solar collectors 2 at the pylon 4 against the gravity G. In order to fix the eight solar collectors 2 to the pylon 4, further as a means there is shown a ladder 21 with which a mechanic (not shown) can climb the pylon 4.

FIG. 10 is a detail view of the fixing device 1 illustrated in FIG. 9. The two collector pedestals 5 are clamped to the pylon 4 with four second pylon clamps 26. Here, two third threaded joints 25 each connect two second pylon clamps 26. By actuating the third threaded joints 25 the distance between the second pylon clamps 26 orthogonal to the pylon 4 can be reduced and thus, the pylon 4 can be clamped between the second pylon clamps 26. Further, two of the four clamp connections 19 can be seen with which the total of eight solar collectors 2 are clamped to the two collector pedestals 5. A ladder 21 is shown as a means with which one can climb the pylon 4 to tighten the third threaded joints 25 of the second pylon clamps 26 and to fix the solar collectors 2 to the pylon 4.

In FIG. 11 there is illustrated the fixing device 1 in which two collector pedestals 5 are fixed with eight solar collectors 2 in total to the pylon 4. In FIG. 11, the reversing device, the lift body, the hauling element, and the winch device are not shown. These were demounted from the pylon 4 to protect the solar collectors 2 from unauthorized removal. Further, symbolically an electrical consumer 20 is shown at the base 22 of the pylon that can be supplied with electric power via the solar collectors 2.

### LIST OF REFERENCE NUMBERS

1 fixing device
2 solar collector
3 site of installation
4 pylon
5 collector pedestal
6 reversing device
7 winch device
8 lift body
9 hauling element
10 first end
11 second end
12 reverse body
13 pulley
14 guiding means
15 abutting pulley
16 first guiding means part
17 second guiding means part
18 first pylon clamp
19 clamp connection
20 consumer
21 ladder
22 base of the pylon
23 first threaded joint
24 second threaded joint
25 third threaded joint
26 second pylon clamp
27 elongated hole
G gravity

1. A fixing device (1) for fixing at least one solar collector (2) to a site of installation (3), preferably to a pylon (4) or the like, wherein the fixing device (1) comprises a collector pedestal (5) for the at least one solar collector (2) that can be fixed to the pylon (4),
a reversing device (6) that can detachably be fixed to the pylon (4),
a winch device (7),
a lift body (8) that is moveable along the pylon (4); and
a hauling element (9),
wherein the hauling element (9) with a first end (10) is fixed to the winch device (7) and with the second end (11) is fixed to the lift body (8),
wherein the hauling element (9) between the first end (10) and the second end (11) is at least partially guided at the reversing device (6),
wherein the hauling element (9) is fixed to the winch device (7) such that the length of the hauling element (9) between winch device (7) and the lift body (8) can be reduced by the hauling element (9) and that the reversing device (6) reverses the hauling element (9) above the site of installation (3) of the at least one solar collector (2) at the pylon (4).

2. The fixing device (1) according to claim 1, characterized in that the reversing device (6) has at least one reverse body (12), wherein the at least one reverse body (12) guides the hauling element (9).

3. The fixing device (1) according to any of the preceding claims, characterized in that the at least one reverse body (12) is a pulley (13).

4. The fixing device (1) according to any of the preceding claims, characterized in that the hauling element (9) is a cable and the winch device (7) is a cable winch.

5. The fixing device (1) according to claim 4, characterized in that the cable winch has a motor, especially an electric motor, for driving.

6. The fixing device (1) according to any of the preceding claims, characterized in that the lift body (8) has a guiding means (14), wherein the guiding means (14) abuts on the pylon (4).

7. The fixing device (1) according to claim 6, characterized in that the guiding means (14) has at least one pulley (15) that abuts on the pylon (4).

8. The fixing device (1) according to claim 6 or 7, characterized in that the guiding means (14) has at least a first guiding means part (16) and a second guiding means part (17), wherein the distance between the first guiding means part (16) and the second guiding means part (17) can be adjusted.

9. The fixing device (1) according to any of the preceding claims, characterized in that the guiding means (14) has at least two pulleys (15) that abut on the pylon (4) the distance of which to each other perpendicular to the pylon (4) can be adjusted.

10. The fixing device (1) according to any of the preceding claims, characterized in that the collector pedestal (5) can be moved along the pylon (4) by means of the lift body (8).

11. The fixing device (1) according to claim 9, characterized in that der collector pedestal (5) has at least two pylon clamps (18) that can be moved substantially perpendicular to the pylon (4) so that the collector pedestal (5) can be clamped to the pylon (4).

12. The fixing device (1) according to claim 9, characterized in that the at least one solar collector (2) can be fixed to the collector pedestal (5) via at least one clamp connection (19).

13. A method for fixing at least one solar collector to a pylon (4) or the like with a fixing device (1) according to any of the preceding claims, wherein the method comprises the following steps:
fixing the reversing device (6) to the pylon (4) above the site of installation (3) of the at least one solar collector (2); and
fixing the winch device (7) to the pylon (4); and
fixing the lift body (8) to the pylon (4) so that the lift body (8) can be moved along the pylon (4); and
fixing the first end (10) of the hauling element (9) to the winch device; and
fixing the second end (11) of the hauling element (9) to the lift body (8), wherein the hauling element (9) is guided over the reversing device (6); and
mounting the at least one solar collector (2) to the collector pedestal (5); and
connecting the collector pedestal (5) to the lift body (8);
actuating the winch device (7) so that the length of the hauling element (9) between the winch device (7) and the lift body (8) is reduced so that the lift body (8) and the collector pedestal (5) connected to the lift body (8) are moved along the pylon (4); and
fixing the collector pedestal (5) to the pylon (4) as soon as the at least one solar collector (2) has reached the desired site of installation (3) at the pylon (4).

14. The method according to claim 12,
characterized in that
after fixing the collector pedestal (5) to the pylon (4) the connection between the lift body (8) and the collector pedestal (5) is loosened; and
the reversing device (6) that can be fixed to the pylon (4), the winch device (7), the lift body (8) that can be moved along the pylon (4) and the hauling element (9) are demounted from the pylon (4).

15. The method for demounting the fixing device (1) according to any of claims 1 to 11, wherein the method comprises the following steps:
fixing the reversing device (6) to the pylon (4) above the site of installation (3) of the at least one solar collector (2), and
fixing the winch device (7) to the base of the pylon (22), and
fixing the lift body (8) to the pylon (4) such that it can be moved along the pylon (4), and
fixing the first end (10) of the hauling element (9) to the winch device, and
fixing the second end (11) of the hauling element (9) to the lift body (8), wherein the hauling element (9) is guided over the reversing device (6),
connecting the collector pedestal (5) to the lift body (8),
loosening the fixation of the collector pedestal (5) on the pylon (4), and
actuating the winch device (7) such that the length of the hauling element (9) between the winch device (7) and the lift body (8) is increased, so that the lift body (8) and the collector pedestal (5) connected to the lift body (8) are moved along the pylon (4), and
loosening the at least one clamp connection between the collector pedestal (5) and the at least one solar collector (2), so that the at least one solar collector (2) can be taken off the collector pedestal (5), and
demounting the reversing device (6) on the pylon (4), the winch device (7) of the lift body (8) that is moveable along the pylon (4), the hauling element (9), and the collector pedestal (5) from the pylon (4).
